(19) United States
(12) Patent Application Publication
(10) Pub. No.: US 2024/0401963 A1
(43) Pub. Date: Dec. 5, 2024

(54) TRAJECTORY PREDICTION APPARATUS AND METHOD

(71) Applicants: HON HAI PRECISION INDUSTRY CO., LTD., New Taipei City (TW); Foxconn Technology Group Co., Ltd., Guangdong Province (CN)

(72) Inventors: Lu-Yao YE, New Taipei City (TW); Zi-Kang ZHOU, New Taipei City (TW); Jian-Ping WANG, New Taipei City (TW); Yung-Hui LI, New Taipei City (TW); Nien-Yi JAN, New Taipei City (TW); Yi-Rong LIN, New Taipei City (TW); Yen-Cheng LIN, New Taipei City (TW)

(21) Appl. No.: 18/677,891

(22) Filed: May 30, 2024

Related U.S. Application Data
(60) Provisional application No. 63/505,058, filed on May 30, 2023.

(51) Int. Cl. G01C 21/36

(52) U.S. Cl. CPC G01C 21/36

(57) ABSTRACT

A trajectory prediction apparatus is configured to execute the following operations. A reference path line is selected from multiple path lines of a scene based on multiple first trajectory coordinates of an object, wherein the first trajectory coordinates and the path lines correspond to a first coordinate system. The first trajectory coordinates of the first coordinate system are transformed into multiple second trajectory coordinates corresponding to a second coordinate system, wherein the second trajectory coordinates indicate relationships of the object corresponding to the reference path line. A predicted trajectory of the object is generated based on the second trajectory coordinates by using a prediction model.

### CROSS-REFERENCE TO RELATED APPLICATION

This application claims priority to U.S. Provisional Application Ser. No. 63/505,058, filed May 30, 2023, which is herein incorporated by reference in its entirety.

### BACKGROUND

### Field of Invention

The present disclosure relates to a trajectory prediction apparatus and method. More particularly, the present disclosure relates to a trajectory prediction apparatus and method based on Frenet coordinate system.

### Description of Related Art

Trajectory prediction technology is widely used in self-driving or driving assistance technologies, and vehicle control is a task with risks to life and property. Therefore, the requirements for the accuracy of prediction and the versatility in different situations are extremely high.

Existing trajectory prediction technology is mostly based on Cartesian coordinate system to represent the trajectory of objects in the driving scene in two-dimensional or three-dimensional space. However, the driving scene is various practically, and the shapes, road conditions, and markings of each of the roads are different. If the trajectory based on the vehicle itself in the space is used for training the prediction model, it will easily make it difficult for the trained prediction model to be widely used in various road conditions in actual scenarios.

In view of this, how to improve the versatility of trajectory prediction is the goal that the industry strives to work on.

### SUMMARY

The disclosure provides a trajectory prediction apparatus comprising a storage and a processor. The storage is configured to store a plurality of first trajectory coordinates of an object and a plurality of path lines of a scene, wherein the first trajectory coordinates and the path lines correspond to a first coordinate system. The processor is coupled to the storage and configured to execute the following operation: selecting a reference path line from the path lines based on the first trajectory coordinates; transforming the first trajectory coordinates in the first coordinate system into a plurality of second trajectory coordinates in a second coordinate system, wherein the second trajectory coordinates are configured to represent a plurality of relationships of the object corresponding to the reference path line; and generating a predicted trajectory of the object by using a prediction model based on the second trajectory coordinates.

The disclosure further provides a trajectory prediction method being adapted for use in an electronic apparatus. The trajectory prediction method comprises the following steps: selecting a reference path line from a plurality of path lines in a scene based on a plurality of first trajectory coordinates of an object, wherein the first trajectory coordinates and the path lines correspond to a first coordinate system; transforming the first trajectory coordinates in the first coordinate system into a plurality of second trajectory coordinates in a second coordinate system, wherein the second trajectory coordinates are configured to represent a plurality of relationships of the object corresponding to the reference path line; and generating a predicted trajectory of the object by using a prediction model based on the second trajectory coordinates.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a trajectory prediction apparatus according to a first embodiment of the present disclosure.

FIG. 2 is a schematic diagram illustrating selecting a reference path line from multiple path lines according to some embodiments of the present disclosure.

FIGS. 3A and 3B are schematic diagrams illustrating coordinate system transformations according to some embodiments of the present disclosure.

FIG. 4 is a schematic diagram illustrating calculating second trajectory coordinates based on nodes in the reference path line and first trajectory coordinates according to some embodiments of the present disclosure.

FIG. 5 is a schematic diagram illustrating turning areas corresponding to the reference path line according to some embodiments of the present disclosure.

FIG. 6 is a schematic diagram illustrating a trajectory prediction method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

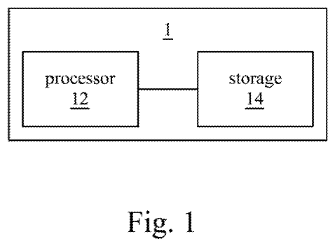

Please refer to FIG. 1, which is a schematic diagram illustrating a trajectory prediction apparatus 1 according to a first embodiment of the present disclosure. The trajectory prediction apparatus 1 comprises a processor 12 and a storage 14, wherein the processor 12 is coupled to the storage 14.

In some embodiments, the processor 12 comprises a central processing unit (CPU), a graphics processing unit (GPU), a multi-processor, a distributed processing system, an application specific integrated circuit (ASIC), and/or a suitable processing unit.

In some embodiments, the storage 14 comprises a semiconductor or solid-state memory, a magnetic tape, a removable computer diskette, a random-access memory (RAM), a read-only memory (ROM), a rigid magnetic disk, and/or an optical disk.

The storage 14 is configured to store a plurality of first trajectory coordinates of an object and a plurality of path lines of a scene, wherein the first trajectory coordinates and the path lines correspond to a first coordinate system.

For example, the storage 14 stores multiple trajectory coordinates traveled by a vehicle while moving in a physical space as the first trajectory coordinates and stores the positions of road markings (e.g., edge lines) in the physical space as the path lines.

The trajectory prediction apparatus 1 is configured to transform the trajectory coordinates of objects corresponding to Cartesian coordinate system into trajectory coordinates corresponding to Frenet coordinate system and execute trajectory prediction on the objects based on the transformed trajectory coordinates, wherein the transformed trajectory coordinates are configured to represent a plurality of relationships of the object corresponding to a reference path line.

For example, the trajectory prediction apparatus 1 is a vehicle-mounted apparatus and configured to transform a vehicle trajectory in a space coordinate system based on the road into trajectory coordinates corresponding to Frenet coordinate system. Also, the trajectory prediction apparatus 1 predicts future trajectories of the vehicle based on the transformed trajectory coordinates accordingly, wherein the transformed trajectory coordinates are configured to represent a distance relationship of the vehicle trajectory and the traffic lane and a path length of the vehicle trajectory corresponding to the traffic lane.

To achieve the function above, the trajectory prediction apparatus 1 is configured to execute the following operation. First, the processor 12 selects a reference path line from the path lines based on the first trajectory coordinates.

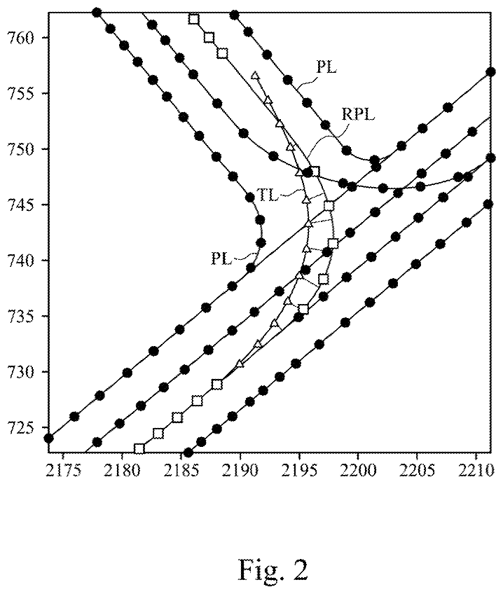

Please refer to FIG. 2, which is a schematic diagram illustrating selecting a reference path line RPL from multiple path lines PL according to some embodiments of the present disclosure. As shown in FIG. 2, in the plane corresponding to Cartesian coordinate system, multiple dots represent multiple path lines PL respectively, and multiple triangles represent a trajectory line TL, wherein the dots are path points, and the triangles are trajectory coordinates. According to the path lines PL and the trajectory line TL, the trajectory prediction apparatus 1 selects a reference path line RPL with the most similar shape and distance from the path lines PL, wherein the path points are represented by multiple squares in the reference path line RPL.

Next, the processor 12 transforms the first trajectory coordinates in the first coordinate system into a plurality of second trajectory coordinates in a second coordinate system, wherein the second trajectory coordinates are configured to represent a plurality of relationships of the object corresponding to the reference path line. In some embodiments, the second trajectory coordinates are further configured to represent a path length and a projection distance of the first trajectory coordinates corresponding to the reference path line.

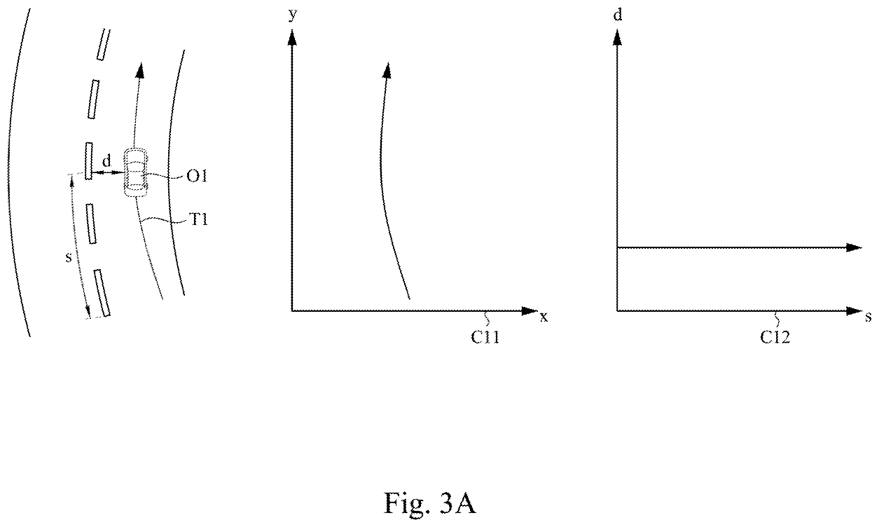

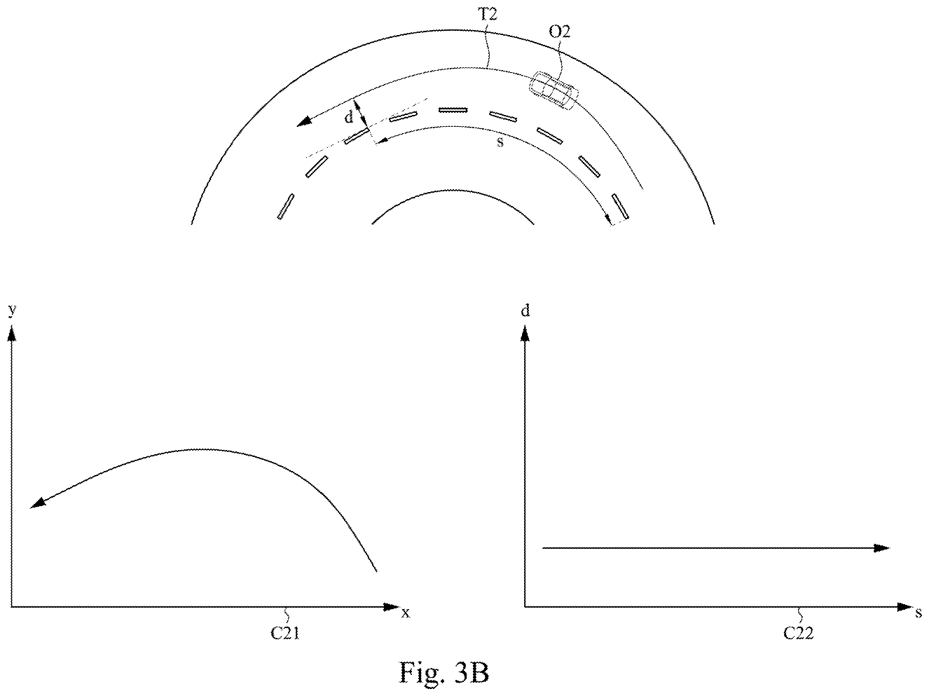

About the operation of transforming the coordinate system, please refer to FIGS. 3A and 3B, as shown in the figures, the vehicles O1 and O2 are driving in a curved lane, and the trajectories T1 and T2 are the driving trajectories respectively. The trajectory T1 of the vehicle O1 is able to be represented as a diagram C11 based on Cartesian coordinate system, and the trajectory T2 of the vehicle O2 is able to be represented as a diagram C21 based on Cartesian coordinate system. Furthermore, the trajectory prediction apparatus 1 transforms the trajectories T1 and T2 of the vehicles O1 and O2 into Frenet coordinate system and representing as diagrams C12 and C22. As shown in the diagrams C12 and C22, the trajectories of the vehicles O1 and O2 is represented as a distance d between the vehicle and the road centerline (i.e., the reference path line) and a vehicle path length s. Since the distance d between the trajectories of the vehicles O1 and O2 and the road centerline in the curved lane is consistence, although the trajectories T1 and T2 are not the same, the transformed trajectories of the vehicles O1 and O2 are identical, wherein the distance d remains constant while the path length s increases.

Finally, the processor 12 generates a predicted trajectory of the object by using a prediction model based on the second trajectory coordinates.

After transforming the trajectory coordinates, the trajectory prediction apparatus 1 performs trajectory prediction on the second trajectory coordinates by using the prediction model to predict a future trajectory of the object. Specifically, the trajectory prediction apparatus 1 takes a machine learning model trained by a training set, wherein the training set is an object trajectory record corresponding to Frenet coordinate system.

Accordingly, since the trajectory prediction apparatus 1 transforms the trajectory coordinates into a form of correspondence with road markings, it is closer to practical driving method that refer to road markings to control the vehicle. Therefore, the prediction model reduces the effect of the road shape while performing trajectory predictions and prevents the accuracy from reducing owing to occurring untrained road shape. Also, the prediction model prevents the situation that suggests the vehicle to keep driving straight because the vehicle went straight for a period of time while the vehicle is about to drive into a curved lane. In other words, compared to existing trajectory prediction technology, the trajectory prediction apparatus 1 in the present disclosure has a higher versatility on prediction scenarios.

About the operation of selecting the reference path line from the path lines, in some embodiments, the trajectory prediction apparatus 1 selects the reference path line based on distances between the first trajectory coordinates and the path lines through the following operations: the processor 12 calculating a distance between each of the first trajectory coordinates and the path lines; and the processor 12 selecting the reference path line based on the distance corresponding to each of the path lines.

For example, the processor 12 calculates the distances between the first trajectory coordinates and the path lines by the following formula 1.

$${S}_{1}^{j} = {[ \frac{1}{n} {Σ}_{t = 1}^{n} {\vert {x}_{t} - \tilde{{x}_{t}^{J}} \vert}_{2} ]}^{- 1} , \qquad ( formula 1 )$$

Wherein j is a serial number corresponding to each of the path lines, si is an Euclidean distances between the first trajectory coordinates and the j-th path line, n is a number of the first trajectory coordinates, t is different time points corresponding to each of the first trajectory coordinates, and [symbol] is a path point on the j-th path line at the t-th time point. Accordingly, the trajectory prediction apparatus 1 selects a path line closest to the object trajectory (i.e., the shortest distance) as the reference path line.

In some embodiments, the trajectory prediction apparatus 1 selects the reference path line based on similarities between the first trajectory coordinates and the path lines through the following operations: the processor 12 calculating a similarity between each of the first trajectory coordinates and the path lines; and the processor 12 selecting the reference path line based on the similarity corresponding to each of the path lines.

For example, the processor 12 calculates the similarities between the first trajectory coordinates and the path lines by the following formula 2.

$${S}_{2}^{j} = {[ \frac{1}{n} {Σ}_{t = 1}^{n} {‖ {x}_{t} - ( \tilde{{x}_{t}^{J}} + Δ {x}^{j} ) ‖}_{2} ]}^{- 1} , \qquad ( formula 2 )$$

Wherein j is a serial number corresponding to each of the path lines, S₂^{j} is similarities between the first trajectory coordinates and the j-th path line, n is a number of the first trajectory coordinates, t is different time points corresponding to each of the first trajectory coordinates, xₜ is the first trajectory coordinate at the t-th time point, [symbol] is a path point on the j-th path line at the t-th time point, and Δx^{j} is an adjustment value corresponding to the j-th path line. Since the vehicle normally maintains a certain distance from the road marking while driving, and the vehicle may be closer to the wrong path line while passing the lane intersection (e.g., the trajectory line TL shown in FIG. 2). Therefore, after shifting the path line to the vehicle trajectory, the formula 2 above further calculates the Euclidean distances between the shifted path line and first trajectory coordinates to obtain the similarities, wherein the processor 12 calculates the adjustment value Δx^{j} by the following formula 3.

$$Δ {x}^{j} = {x}_{T} - \tilde{{x}_{T}^{J}} , \qquad ( formula 3 )$$

Wherein x_{T} is the current location of the object (i.e., the last trajectory coordinate), and [symbol] is the projected coordinate of the current location on the path line. Accordingly, the trajectory prediction apparatus 1 selects a path line with the most similar shape with the object trajectory as the reference path line.

In some embodiments, the trajectory prediction apparatus 1 selects the reference path line based on both of the distances and the similarities between the first trajectory coordinates and the path lines. For example, the processor 12 calculates the weight of each of the path lines by the following formula 4 based on the result of the formula 1 and 2.

$${j}^{*} = arg max ( {S}_{1}^{j} + {S}_{2}^{j} ) , \qquad ( formula 4 )$$

Wherein j* is the weight of the j-th path line. Furthermore, the processor 12 selects the path line with the highest weight as the reference path line.

As to the operation of transforming the first trajectory coordinates into the second trajectory coordinates, in some embodiments, the trajectory prediction apparatus 1 transforms the first trajectory coordinates into the second trajectory coordinates through the following operations: the processor 12 calculating a projected coordinate of each of the first trajectory coordinates on the reference path line; the processor 12 calculating a projection distance between each of the first trajectory coordinates and the corresponding projected coordinate; and the processor 12 generating the second trajectory coordinates based on the projected coordinate and the projection distance corresponding to each of the first trajectory coordinates.

Furthermore, in some embodiments, the reference path line is formed by a plurality of nodes, and the operation of the processor 12 transforming the first trajectory coordinates into the second trajectory coordinates further comprises: the processor 12 selecting a first node and a second node closest to the projected coordinate of each of the first trajectory coordinates from the nodes; the processor 12 calculating a path length between the projected coordinate of each of the first trajectory coordinates and the corresponding first node; and the processor 12 generating the second trajectory coordinates based on the projected coordinate, the projection distance, and the path length corresponding to each of the first trajectory coordinates.

Furthermore, in some embodiments, the operation of the processor 12 transforming the first trajectory coordinates into the second trajectory coordinates further comprises: the processor 12 calculating a first vector formed by the first node and the second node corresponding to each of the first trajectory coordinates; the processor 12 calculating a second vector formed by the first node and the projected coordinate corresponding to each of the first trajectory coordinates; the processor 12 calculating a direction relationship between the first vector and the second vector corresponding to each of the first trajectory coordinates; and the processor 12 generating the second trajectory coordinates based on the projected coordinate, the projection distance, the path length, and the direction relationship corresponding to each of the first trajectory coordinates.

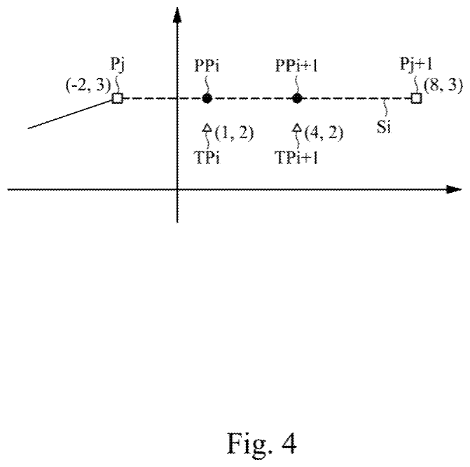

For example, please refer to FIG. 4, which is a schematic diagram illustrating calculating second trajectory coordinates based on nodes Pj and Pj+1 in the reference path line and first trajectory coordinates TPi and TPi+1 according to some embodiments of the present disclosure, wherein the nodes Pj and Pj+1 are the j-th and j+1-th nodes on the reference path line respectively.

As shown in FIG. 4, the first trajectory coordinates TPi and TPi+1 project at the projection points PPi and PPi+1 respectively on the reference path line, and the projection points PPi and PPi+1 are located between the nodes Pj and Pj+1 (i.e., the nodes Pj and Pj+1 are the first node and the second node).

First, the processor 12 calculates the segment Sj formed by the nodes Pj and Pj+1, wherein the segment Sj is represented by the following formula 5.

$$y = {k}^{J} x + {b}^{J} , \qquad ( formula 5 )$$

Wherein x and y are coordinates on the segment Sj, k^{J} and b^{J} are parameters. Referring to the coordinates (−2, 3) and (8, 3) of the nodes Pj and Pj+1 shown in FIG. 4, it is calculated that k^{J} is 0 and b^{J} is 3.

Next, the processor 12 calculates the coordinates of the projection points PPi and PPi+1 of the first trajectory coordinates TPi and TPi+1 on the segment Sj.

$$\tilde{{x}_{t}} = \frac{{k}^{J} ( {y}_{t} - {b}^{J} ) + {x}_{t}}{{( {k}^{J} )}^{2} + 1} , \qquad ( formula 6 )$$

$$\tilde{{y}_{t}} = {k}^{J} \tilde{{x}_{t}} + {b}^{J} ,$$

Wherein [symbol] and [symbol] are projected coordinates at the t-th time point, and xₜ and yₜ are the first trajectory coordinates at the t-th time point. Accordingly, the processor 12 calculates the coordinates of the projection points PPi and PPi+1 are (1, 3) and (4, 3) respectively.

Next, the processor 12 calculates the second trajectory coordinates based on the projection points PPi and PPi+1 by the following formula 7.

$$F = ( {s}_{t} , {d}_{t} ) , \qquad ( formula 7 )$$

$${d}_{t} = {I}_{t} \cdot {‖ \tilde{{x}_{t}} - {x}_{t} ‖}_{2} ,$$

$${I}_{t} = \{ \begin{matrix}- 1 , if \vec{{P}^{J} {P}^{J + 1}} \cdot \vec{{P}^{J} {x}_{t}} < 0 , \\ 1 , if \vec{{P}^{J} {P}^{J + 1}} \cdot \vec{{P}^{J} {x}_{t}} \geq 0 ,\end{matrix} ,$$

$${s}_{t} = {\sum }_{i = 2}^{n} ‖ {P}^{i} - {P}^{i + 1} ‖ + ‖ \tilde{{x}_{t}} - {P}^{J} ‖ ,$$

Wherein F is a second trajectory coordinate at the t-th time point, sₜ is the path length, dₜ is the projection distance, P is a node on the reference path line, P^{J} and P^{J+1} are the nodes Pj and Pj+1, Iₜ is a vector configured to indicate a direction relationship between the direction vector of the node Pj towards the node Pj+1 (i.e., the first vector) and the direction vector of the node Pj towards the first trajectory coordinate (i.e., the second vector). Taking the first trajectory coordinates TPi and TPi+1 as an example, both of them are located on the right side of the direction vector of the node Pj towards the node Pj+1, thus the Iₜ is −1.

In the embodiment shown in FIG. 4, through the operation above, the processor 12 obtains a second trajectory coordinate (3, −1) corresponding to the first trajectory coordinate TPi, wherein 3 indicates the path length between the previous closest node Pj on the reference path line and the projection point PPi corresponding to the first trajectory coordinate TPi, the plus or minus sign of −1 indicates which side of the reference path line is the first trajectory coordinate TPi located on, and the value of −1 indicates the distance between the first trajectory coordinate TPi and the projection point PPi.

However, in some circumstances, the reference path line comprises multiple nodes and is formed by polylines connected by the adjacent nodes. However, when the first trajectory coordinates locate near the turning points of the polylines, the trajectory prediction apparatus 1 is not able to calculate the projection points corresponding to the first trajectory coordinates through the operations above. Therefore, in some embodiments,
the operation of the processor 12 transforming the first trajectory coordinates into the second trajectory coordinates further comprises: in response to one of the first trajectory coordinates located in a turning area corresponding to the reference path line, the processor 12 generating the projected coordinate of the one of the first trajectory coordinates based on a turning point of the turning area.

Furthermore, in some embodiments, the operation of the processor 12 transforming the first trajectory coordinates into the second trajectory coordinates further comprises: the processor 12 calculating a first slope and a second slope adjacent to two adjacent segments of the turning point on the reference path line; the processor 12 calculating a third slope between each of the first trajectory coordinates and the turning point; and the processor 12 determining whether each of based on the first slope, the second slope, and the third slope corresponding to each of the first trajectory coordinates.

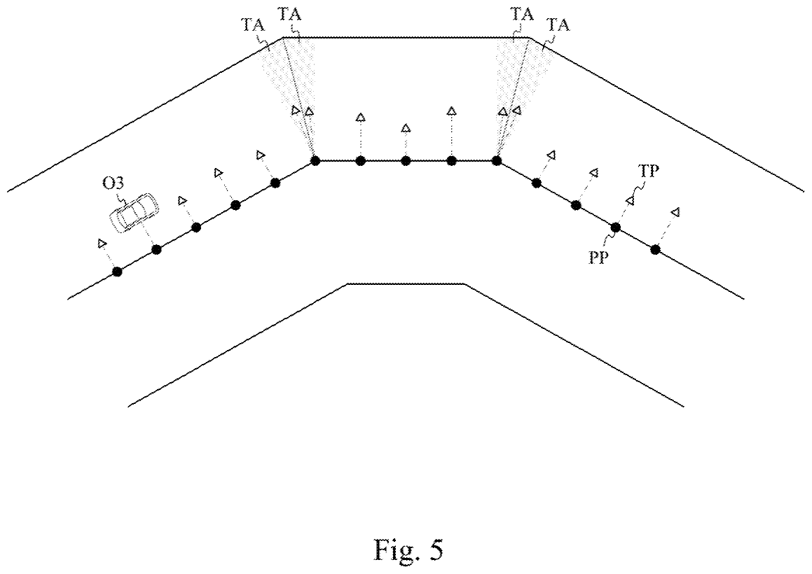

For example, please refer to FIG. 5, there are two turning points on the reference path line, and there is no non-vertical tangent line corresponding to the turning points (i.e., the reference path line is not differentiable on the turning points). Therefore, the processor 12 is not able to calculate projection points PP (indicated by dots) corresponding to first trajectory coordinates TP (indicated by triangles) of an object O3 in turning areas TA.

The processor 12 determines whether the first trajectory coordinates TP are located in the turning areas TA by the following formula 8.

$$\hat{p} = \{ ( x , y ) \vert - \frac{1}{{k}_{1}} < \frac{y - {y}^{*}}{x - {x}^{*}} < - \frac{1}{{k}_{2}} \} , \qquad ( formula 8 )$$

Wherein \hat{p} is a set of turning point coordinates (x, y), k₁ and k₂ are the first slope and the second slope on two sides of the turning point, the turning point coordinate is (x*, y*), and y−y*/x−x* is the third slope. Namely, if one of the first trajectory coordinate TP belongs to the set \hat{p}, the processor 12 determines the one of the first trajectory coordinate TP is located in the turning areas TA.

Furthermore, when determining the one of the first trajectory coordinate TP is located in the turning areas TA, the processor 12 takes the turning point corresponding to the turning areas TA as a projection point PP of the one of the first trajectory coordinate TP.

In summary, the trajectory prediction apparatus 1 of the present disclosure transforms object trajectory coordinates based on positions in a space into object trajectory coordinates based on a reference line and further performs trajectory prediction based on the transformed trajectory coordinates. Since the transformed trajectory coordinates are less affected by road shapes, the invention in the present disclosure improves the versatility of the trajectory prediction model. Additionally, when the reference path line is not differentiable and the projected coordinates are not able to be calculated, the trajectory prediction apparatus 1 determines whether the trajectory coordinates are located in turning areas of the reference path line and adjusts the calculation method of the projected coordinates accordingly.

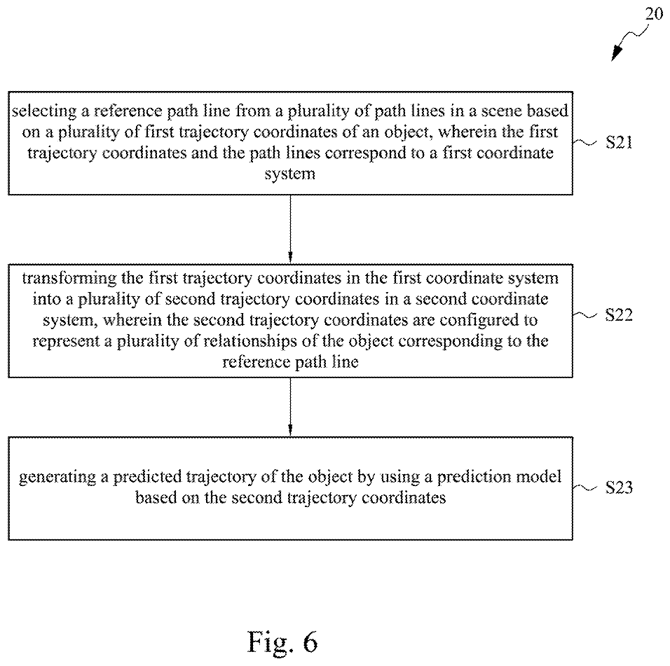

Please refer to FIG. 6, which is a schematic diagram illustrating a trajectory prediction method 20 according to a second embodiment of the present disclosure. The trajectory prediction method 20 comprises steps S21-S23. The trajectory prediction method 20 is configured to transform the trajectory coordinates of objects corresponding to Cartesian coordinate system into trajectory coordinates corresponding to Frenet coordinate system and execute trajectory prediction on the objects based on the transformed trajectory coordinates, wherein the transformed trajectory coordinates are configured to represent a plurality of relationships of the object corresponding to a reference path line. The trajectory prediction method 20 can be executed by an electronic apparatus (e.g., the trajectory prediction apparatus 1 shown in FIG. 1), and the electronic apparatus comprises a processor (e.g., the processor 12 shown in FIG. 1).

First, in the step S21, the electronic apparatus selects a reference path line from a plurality of path lines in a scene based on a plurality of first trajectory coordinates of an object, wherein the first trajectory coordinates and the path lines correspond to a first coordinate system.

Next, in the step S22, the electronic apparatus transforms the first trajectory coordinates in the first coordinate system into a plurality of second trajectory coordinates in a second coordinate system, wherein the second trajectory coordinates are configured to represent a plurality of relationships of the object corresponding to the reference path line.

Finally, in the step S23, the electronic apparatus generates a predicted trajectory of the object by using a prediction model based on the second trajectory coordinates.

In some embodiments, the step S21 further comprises the electronic apparatus calculating a distance between each of the first trajectory coordinates and the path lines; and the electronic apparatus selecting the reference path line based on the distance corresponding to each of the path lines.

In some embodiments, the step S21 further comprises the electronic apparatus calculating a similarity between each of the first trajectory coordinates and the path lines; and the electronic apparatus selecting the reference path line based on the similarity corresponding to each of the path lines.

In some embodiments, the step S21 further comprises the electronic apparatus calculating a distance between each of the first trajectory coordinates and the path lines; the electronic apparatus calculating a similarity between each of the first trajectory coordinates and the path lines; the electronic apparatus calculating a weight of each of the path lines based on the distance and the similarity corresponding to each of the path lines; and the electronic apparatus selecting the reference path line based on the weight corresponding to each of the path lines.

In some embodiments, the step S22 further comprises the electronic apparatus calculating a projected coordinate of each of the first trajectory coordinates on the reference path line; the electronic apparatus calculates a projection distance between each of the first trajectory coordinates and the corresponding projected coordinate; and the electronic apparatus generating the second trajectory coordinates based on the projected coordinate and the projection distance corresponding to each of the first trajectory coordinates.

In some embodiments, the reference path line comprises a plurality of nodes, and the step S22 further comprises the electronic apparatus selecting a first node and a second node closest to the projected coordinate of each of the first trajectory coordinates from the nodes; the electronic apparatus calculating a path length between the projected coordinate of each of the first trajectory coordinates and the corresponding first node; and the electronic apparatus generating the second trajectory coordinates based on the projected coordinate, the projection distance, and the path length corresponding to each of the first trajectory coordinates.

In some embodiments, the step S22 further comprises the electronic apparatus calculating a first vector formed by the first node and the second node corresponding to each of the first trajectory coordinates; the electronic apparatus calculating a second vector formed by the first node and the projected coordinate corresponding to each of the first trajectory coordinates; the electronic apparatus calculating a direction relationship between the first vector and the second vector corresponding to each of the first trajectory coordinates; and the electronic apparatus generating the second trajectory coordinates based on the projected coordinate, the projection distance, the path length, and the direction relationship corresponding to each of the first trajectory coordinates.

In some embodiments, the step S22 further comprises in response to one of the first trajectory coordinates located in a turning area corresponding to the reference path line, the electronic apparatus generating the projected coordinate of the one of the first trajectory coordinates based on a turning point of the turning area.

In some embodiments, the step S22 further comprises the electronic apparatus calculating a first slope and a second slope adjacent to two adjacent segments of the turning point on the reference path line; the electronic apparatus calculating a third slope between each of the first trajectory coordinates and the turning point; and the electronic apparatus determining whether each of the first trajectory coordinates is located in the turning area based on the first slope, the second slope, and the third slope corresponding to each of the first trajectory coordinates.

In some embodiments, the second trajectory coordinates are further configured to represent a path length and a projection distance of the first trajectory coordinates corresponding to the reference path line.

In summary, the trajectory prediction method 20 of the present disclosure transforms object trajectory coordinates based on positions in a space into object trajectory coordinates based on a reference line and further performs trajectory prediction based on the transformed trajectory coordinates. Since the transformed trajectory coordinates are less affected by road shapes, the invention in the present disclosure improves the versatility of the trajectory prediction model. Additionally, when the reference path line is not differentiable and the projected coordinates are not able to be calculated, the trajectory prediction method 20 determines whether the trajectory coordinates are located in turning areas of the reference path line and adjusts the calculation method of the projected coordinates accordingly.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A trajectory prediction apparatus, comprising:
a storage, configured to store a plurality of first trajectory coordinates of an object and a plurality of path lines of a scene, wherein the first trajectory coordinates and the path lines correspond to a first coordinate system; and
a processor, coupled to the storage, configured to execute the following operation:
selecting a reference path line from the path lines based on the first trajectory coordinates;
transforming the first trajectory coordinates in the first coordinate system into a plurality of second trajectory coordinates in a second coordinate system, wherein the second trajectory coordinates are configured to represent a plurality of relationships of the object corresponding to the reference path line; and
generating a predicted trajectory of the object by using a prediction model based on the second trajectory coordinates.

2. The trajectory prediction apparatus of claim 1, wherein the operation of selecting the reference path line from the path lines further comprises:
calculating a distance between each of the first trajectory coordinates and the path lines; and
selecting the reference path line based on the distance corresponding to each of the path lines.

3. The trajectory prediction apparatus of claim 1, wherein the operation of selecting the reference path line from the path lines further comprises:
calculating a similarity between each of the first trajectory coordinates and the path lines; and
selecting the reference path line based on the similarity corresponding to each of the path lines.

4. The trajectory prediction apparatus of claim 1, wherein the operation of selecting the reference path line from the path lines further comprises:
calculating a distance between each of the first trajectory coordinates and the path lines;
calculating a similarity between each of the first trajectory coordinates and the path lines;
calculating a weight of each of the path lines based on the distance and the similarity corresponding to each of the path lines; and
selecting the reference path line based on the weight corresponding to each of the path lines.

5. The trajectory prediction apparatus of claim 1, wherein the operation of transforming the first trajectory coordinates into the second trajectory coordinates further comprises:
calculating a projected coordinate of each of the first trajectory coordinates on the reference path line;
calculating a projection distance between each of the first trajectory coordinates and the corresponding projected coordinate; and
coordinate and the projection distance corresponding to each of the first trajectory coordinates.

6. The trajectory prediction apparatus of claim 5, wherein the reference path line comprises a plurality of nodes, and the operation of transforming the first trajectory coordinates into the second trajectory coordinates further comprises:
selecting a first node and a second node closest to the projected coordinate of each of the first trajectory coordinates from the nodes;
calculating a path length between the projected coordinate of each of the first trajectory coordinates and the corresponding first node; and
generating the second trajectory coordinates based on the projected coordinate, the projection distance, and the path length corresponding to each of the first trajectory coordinates.

7. The trajectory prediction apparatus of claim 6, wherein the operation of transforming the first trajectory coordinates into the second trajectory coordinates further comprises:
calculating a first vector formed by the first node and the second node corresponding to each of the first trajectory coordinates;
calculating a second vector formed by the first node and the projected coordinate corresponding to each of the first trajectory coordinates;
calculating a direction relationship between the first vector and the second vector corresponding to each of the first trajectory coordinates; and
coordinate, the projection distance, the path length, and the direction relationship corresponding to each of the first trajectory coordinates.

8. The trajectory prediction apparatus of claim 5, wherein the operation of transforming the first trajectory coordinates into the second trajectory coordinates further comprises:
in response to one of the first trajectory coordinates located in a turning area corresponding to the reference path line, generating the projected coordinate of the one of the first trajectory coordinates based on a turning point of the turning area.

9. The trajectory prediction apparatus of claim 8, wherein the operation of transforming the first trajectory coordinates into the second trajectory coordinates further comprises:
calculating a first slope and a second slope adjacent to two adjacent segments of the turning point on the reference path line;
calculating a third slope between each of the first trajectory coordinates and the turning point; and
determining whether each of the first trajectory coordinates is located in the turning area based on the first slope, the second slope, and the third slope corresponding to each of the first trajectory coordinates.

10. The trajectory prediction apparatus of claim 1, wherein the second trajectory coordinates are further configured to represent a path length and a projection distance of the first trajectory coordinates corresponding to the reference path line.

11. A trajectory prediction method, being adapted for use in an electronic apparatus, wherein the trajectory prediction method comprises the following steps:
selecting a reference path line from a plurality of path lines in a scene based on a plurality of first trajectory coordinates of an object, wherein the first trajectory coordinates and the path lines correspond to a first coordinate system;
transforming the first trajectory coordinates in the first coordinate system into a plurality of second trajectory coordinates in a second coordinate system, wherein the second trajectory coordinates are configured to represent a plurality of relationships of the object corresponding to the reference path line; and
generating a predicted trajectory of the object by using a prediction model based on the second trajectory coordinates.

12. The trajectory prediction method of claim 11, wherein the step of selecting the reference path line from the path lines further comprises:
calculating a distance between each of the first trajectory coordinates and the path lines; and
selecting the reference path line based on the distance corresponding to each of the path lines.

13. The trajectory prediction method of claim 11, wherein the step of selecting the reference path line from the path lines further comprises:
calculating a similarity between each of the first trajectory coordinates and the path lines; and
selecting the reference path line based on the similarity corresponding to each of the path lines.

14. The trajectory prediction method of claim 11, wherein the step of selecting the reference path line from the path lines further comprises:
calculating a distance between each of the first trajectory coordinates and the path lines;
calculating a similarity between each of the first trajectory coordinates and the path lines;
calculating a weight of each of the path lines based on the distance and the similarity corresponding to each of the path lines; and
selecting the reference path line based on the weight corresponding to each of the path lines.

15. The trajectory prediction method of claim 11, wherein the step of transforming the first trajectory coordinates into the second trajectory coordinates further comprises:
calculating a projected coordinate of each of the first trajectory coordinates on the reference path line;
calculating a projection distance between each of the first trajectory coordinates and the corresponding projected coordinate; and
coordinate and the projection distance corresponding to each of the first trajectory coordinates.

16. The trajectory prediction method of claim 15, wherein the reference path line comprises a plurality of nodes, and the step of transforming the first trajectory coordinates into the second trajectory coordinates further comprises:
selecting a first node and a second node closest to the projected coordinate of each of the first trajectory coordinates from the nodes;
calculating a path length between the projected coordinate of each of the first trajectory coordinates and the corresponding first node; and
generating the second trajectory coordinates based on the projected coordinate, the projection distance, and the path length corresponding to each of the first trajectory coordinates.

17. The trajectory prediction method of claim 16, wherein the step of transforming the first trajectory coordinates into the second trajectory coordinates further comprises:
calculating a first vector formed by the first node and the second node corresponding to each of the first trajectory coordinates;
calculating a second vector formed by the first node and the projected coordinate corresponding to each of the first trajectory coordinates;
calculating a direction relationship between the first vector and the second vector corresponding to each of the first trajectory coordinates; and
coordinate, the projection distance, the path length, and the direction relationship corresponding to each of the first trajectory coordinates.

18. The trajectory prediction method of claim 15, wherein the step of transforming the first trajectory coordinates into the second trajectory coordinates further comprises:
in response to one of the first trajectory coordinates located in a turning area corresponding to the reference path line, generating the projected coordinate of the one of the first trajectory coordinates based on a turning point of the turning area.

19. The trajectory prediction method of claim 18, wherein the step of transforming the first trajectory coordinates into the second trajectory coordinates further comprises:
calculating a first slope and a second slope adjacent to two adjacent segments of the turning point on the reference path line;
calculating a third slope between each of the first trajectory coordinates and the turning point; and
determining whether each of the first trajectory coordinates is located in the turning area based on the first slope, the second slope, and the third slope corresponding to each of the first trajectory coordinates.

20. The trajectory prediction method of claim 11, wherein the second trajectory coordinates are further configured to represent a path length and a projection distance of the first trajectory coordinates corresponding to the reference path line.
